(19) United States
(12) Patent Application Publication
(10) Pub. No.: US 2026/0279361 A1
(43) Pub. Date: Sep. 17, 2026

(54) Processing Spatial Descriptors from Higher Order Ambisonics Data

(71) Applicant: Apple Inc., Cupertino, CA (US)

(72) Inventors: Moo Young Kim, San Diego, CA (US); Dipanjan Sen, Dublin, CA (US); Ravi Kiran Chivukula, San Jose, CA (US); Tejaswi Nanjundaswamy, San Jose, CA (US)

(21) Appl. No.: 19/079,074

(22) Filed: Mar. 13, 2025

(51) Int. Cl. G10L 19/008; G10L 19/00; G10L 19/035; G10L 19/038

(52) U.S. Cl. CPC G10L 19/008; G10L 19/0017; G10L 19/035; G10L 19/038; G10L 2019/0004

(57) ABSTRACT

Encoding, decoding, and processing spatial descriptors (SD) produced from higher order ambisonics (HOA) data for purposes of bitrate reduction is described. Some aspects include encoding an SD by subtracting a mean vector, multiplying a unitary transform matrix, clustering, and/or lossless encoding, and/or decoding an SD by adding a mean vector, multiplying an inverse of the unitary transform matrix, processing clusters, and/or lossless decoding. Other aspects are also described and claimed.

### BACKGROUND

### Field

This disclosure relates generally to digital audio signal processing and, more specifically, to processing spatial descriptors from higher order ambisonics data. Other aspects are also described.

### Background Information

A sound field can be represented by a summation of weighted, spherical harmonic basis functions of increasing order 0, 1, 2, etc. As the set of basis functions is extended to include higher order elements (order two and higher), the representation of the sound field becomes more detailed (higher resolution). The weights that are applied to the basis functions are referred to as spherical harmonic coefficients. The term higher order ambisonics, HOA, data is used generically to refer to such a representation of a sound field.

Digital audio content in which a sound field is represented by HOA data may be transferred over a communication link from one location to another location, for playback at the latter location over an arbitrary sound output system. At the sound output system, the HOA data is transformed, through digital signal processing (DSP), into speaker driver signals. Examples include loudspeaker driver signals of for instance a two channel loudspeaker system or a 5.1 surround sound system, and binaural left and right headphone driver signals. The communication link, however, may not always have sufficient bandwidth to transfer raw or uncompressed HOA data for real-time, pause-free playback. Some codec techniques have been proposed to encode and in particular compress the raw HOA data into a reduced bitrate encoded bitstream, for transfer over a limited bandwidth communication link, and then decode the bitstream to synthesize the raw HOA data at the destination sound output system (before transforming the decoded HOA data to speaker driver signals for playback). These include the use of singular value decomposition, SVD, and eigenvalue decomposition, EVD, which are matrix factorization techniques that are applied to an input H matrix that contains the spherical harmonic coefficients which are a large part of the HOA data. The matrix factorization techniques are applied in a way that extracts components that contain foreground sounds (also referred to as direct or predominant sounds) and their associated “spatial components,” the latter serving to describe some spatial aspects of the foreground sound components. The extracted foreground sound components and their accompanying spatial components may then be quantized before transmission through the communication link. At the decoding side, the received foreground and spatial components are processed by a reconstruction algorithm to synthesize a recovered Ĥ matrix.

### SUMMARY

Implementations of this disclosure include processing spatial descriptors (SDs) produced from higher order ambisonics (HOA) data to achieve higher bitrate reduction. As described herein, higher bitrate reduction may be achieved by processing the SDs by one or more techniques, such as encoding an SD by subtracting a mean vector, multiplying a unitary transform matrix, clustering, and/or lossless encoding, and/or decoding an SD by adding a mean vector, multiplying an inverse of the unitary transform matrix, processing clusters, and/or lossless decoding, among other techniques. Other aspects are also described and claimed.

Some implementations may include a method for encoding a k-dimensional spatial descriptor (SD) produced from higher order ambisonics (HOA) data, including multiplying a unitary transform matrix by an input k-dimensional SD to produce a k-dimensional transformed SD; and encoding the k-dimensional transformed SD into a bitstream to be transmitted to a decoder.

Some implementations may include method for decoding a k-dimensional spatial descriptor (SD) produced from higher order ambisonics (HOA) data, including receiving a bitstream; generating a k-dimensional transformed SD based on the bitstream; determining an inverse of a unitary transform; and multiplying the k-dimensional transformed SD by the inverse of the unitary transform to produce an output k-dimensional SD to reconstruct HOA data.

Some implementations may include method for processing a bitstream including a k-dimensional spatial descriptor (SD) produced from higher order ambisonics (HOA) data, including receiving a bitstream that includes a k-dimensional transformed SD and a transform index; and processing the bitstream by multiplying the k-dimensional transformed SD by an inverse of a unitary transform matrix determined from a transform codebook based on the transform index to produce an output k-dimensional SD to reconstruct HOA data. Other aspects are also described and claimed.

The above summary does not include an exhaustive list of all aspects of the present disclosure. It is contemplated that the disclosure includes all systems and methods that can be practiced from all suitable combinations of the various aspects summarized above, as well as those disclosed in the Detailed Description below and particularly pointed out in the Claims section. Such combinations may have particular advantages not specifically recited in the above summary.

### BRIEF DESCRIPTION OF THE DRAWINGS

Several aspects of the disclosure here are illustrated by way of example and not by way of limitation in the figures of the accompanying drawings in which like references indicate similar elements. It should be noted that references to “an” or “one” aspect in this disclosure are not necessarily to the same aspect, and they mean at least one. Also, in the interest of conciseness and reducing the total number of figures, a given figure may be used to illustrate the features of more than one aspect of the disclosure, and not all elements in the figure may be required for a given aspect.

FIG. 1 is an example of a system for processing spatial descriptors from higher order ambisonics data via unitary transform based split vector quantization.

FIG. 2 is an example of a system for processing spatial descriptors from higher order ambisonics data via unitary transform based multi-cluster split vector quantization.

FIG. 3 is an example of a system for processing spatial descriptors from higher order ambisonics data via unitary transform based lossless coding.

FIG. 4 is an example of a system for processing spatial descriptors from higher order ambisonics data via unitary transform based multi-cluster lossless coding.

FIGS. 5A-5B and FIGS. 6A-6B show examples of processing higher order ambisonics data with principal components analysis coding and window switching.

FIGS. 7A-7B show an example of a processing higher order ambisonics data with dynamic selection of salient objects.

### DETAILED DESCRIPTION

Bitrate is an important consideration in digital audio communications. Transmitting audio signals with higher bitrates generally require more time and/or bandwidth to complete. While audio signals with lower bitrates may be transmitted faster and/or with less bandwidth, in conventional systems a reduction in bitrate may translate to a reduction of sound quality by the receiver. It is therefore generally desirable to reduce bitrates of audio signal transmissions while maintaining sound quality.

Implementations of this disclosure address problems such as these by processing SDs produced from HOA data to achieve higher bitrate reduction. Digital audio content from a sound field may be represented by HOA data. The HOA data may be transferred over a communication link from one location to another location, for playback at the latter location over an arbitrary sound output system. An SD may be produced from the HOA data by performing principal components analysis, PCA, or any transform based upon an HOA matrix, e.g., matching pursuit. The SD may be accompanied by salient components, SCs, that are extracted from the HOA matrix, e.g., a mean subtracted HOA matrix. An SD describes spatial aspects of a corresponding, or i-th, SC, such as its direction of arrival and its diffuseness. In some cases, the total number of SDs may be equal to the total number of corresponding SCs. The SC is an audio signal that may be extracted by solving an equation based on the HOA matrix and the SD. As described herein, higher bitrate reduction may be achieved by processing the SDs by one or more techniques, such as encoding an SD by subtracting a mean vector, multiplying a unitary transform matrix, clustering, lossless encoding, decoding an SD by adding a mean vector, multiplying an inverse of the unitary transform matrix, processing clusters, and/or lossless decoding, among other techniques.

Embodiments describe processing spatial descriptors from HOA data. In various embodiments, description is made with reference to figures. However, certain embodiments may be practiced without one or more of these specific details, or in combination with other known methods and configurations. In the following description, numerous specific details are set forth, such as specific configurations, dimensions, processes, etc., in order to provide a thorough understanding of the embodiments. In other instances, well-known processes and manufacturing techniques have not been described in particular detail in order to not unnecessarily obscure the embodiments. Reference throughout this specification to “one embodiment” means that a particular feature, structure, configuration, or characteristic described in connection with the embodiment is included in at least one embodiment. Thus, the appearances of the phrase “in one embodiment” in various places throughout this specification are not necessarily referring to the same embodiment. Furthermore, the particular features, structures, configurations, or characteristics may be combined in any suitable manner in one or more embodiments.

In the following figures, the elements of these systems are digital electronics such as one or more processors (generically referred to here as “a processor”) that are configured for example according to instructions stored in memory to perform certain digital signal processing operations described below. An encoder or encoding side produces an encoded audio content bitstream that may be transmitted, to be carried for example over the Internet or any communications link that may experience bandwidth fluctuations or that may have limited bandwidth, to a decoder or decoding side. The encoding side may be for example part of a system having a number of microphones by which a sound field is captured and then formatted as HOA data. The decoding side may be part of a playback system having sound output transducers or speaker drivers (e.g., loudspeakers, headphones) through which the HOA data is output as sound after being decoded and converted into the appropriate speaker driver signals.

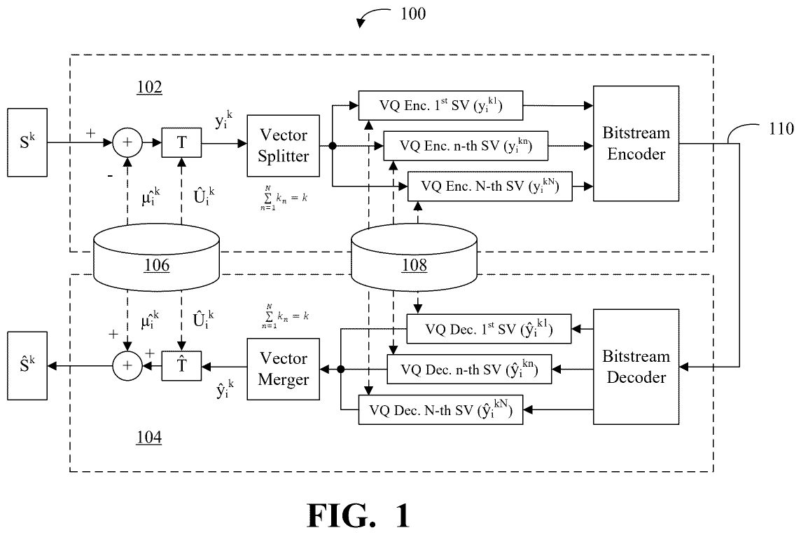

FIG. 1 is an example of a system 100 for processing SDs produced from HOA data. The SDs may be produced by performing PCA based upon an HOA matrix (e.g., a mean subtracted HOA matrix). The system 100 utilizes a unitary transform based split vector quantization (UT-SVQ) technique as described below.

The system 100 may include an encoder 102 that encodes a bitstream 110, a decoder 104 that decodes the bitstream 110, and/or one or more codebooks. The encoder 102 may include a mean subtractor, a matrix multiplier, a vector splitter, a plurality of vector quantization (VQ) encoders, and a bitstream encoder. In an example of an encoding side of the process, from an input k-dimensional SD, S^{k}, produced from HOA data, a mean vector,

$${\hat{μ}}_{i}^{k} ,$$

is subtracted by the mean subtractor to produce a mean subtracted k-dimensional SD. The mean vector that is subtracted is selected from a mean vector codebook, such as a first entry of a codebook 106 (e.g., a mean vector and unitary transform codebook of an i-th cluster). An index of the selected mean vector may be transmitted to the decoder 104 in the bitstream 110.

From the mean subtracted k-dimensional SD, a unitary transform matrix, Ûᵢ^{k}, is multiplied via the matrix multiplier to produce a k-dimensional transformed SD, ŷᵢ^{k}. For example,

$${\hat{y}}_{i}^{k} = {\hat{U}}_{i}^{k} ( {S}^{k} - {\hat{μ}}_{i}^{k} ) .$$

In the context of vectors, the multiplication may be viewed as a matrix multiplication of the mean subtracted k-dimensional SD (vector) by the unitary transform matrix (vector). The unitary transform matrix that is multiplied is selected from a unitary transform matrix codebook, such as a second entry of the codebook 106. The index of the selected unitary transform matrix may also be transmitted to the decoder 104 in the bitstream 110. There may be multiple codebooks for a mean vector and a unitary transform matrix. In this example, the i-th codebook pair for a mean vector and a unitary transform matrix is shown.

The vector splitter splits the k-dimensional transformed SD to N sub-vectors (SVs) based on the codebook 108 where N is an integer greater than or equal to one (e.g., a VQ encoding of an i-th cluster and a first sub-vector yᵢ^{k1}, a VQ encoding of an i-th cluster and an n-th sub-vector yᵢ^{kn}, and a VQ encoding of an i-th cluster and an N-th sub-vector yᵢ^{kN}). In some implementations, each of the sub-vectors may have different dimensions. Then, VQ encoding of an (i-th cluster and) n-th sub-vector (SV) may be performed by an N number of VQ encoders based on a codebook of an (i-th cluster and) n-th sub-vector, such as entries of a codebook 108 (e.g., a codebook of an i-th cluster and an n-th sub-vector where 1≤n≤Nᵢ). Then, the bitstream encoder may generate the bitstream 110 (e.g., of an i-th cluster SD), including the index of the selected mean vector, the index of the selected unitary transform matrix, and indices generated by the N number of VQ encoders. The bitstream 110 may be transmitted to the decoder 104 and/or stored in a non-transitory machine-readable medium.

Still referring to FIG. 1, in an example of a decoding side of the process (UT-SVQ i-th cluster decoding), the decoder 104 may include a bitstream decoder, a plurality of VQ decoders, a vector merger, an inverse matrix multiplier, and an adder. The bitstream decoder may decode the received bitstream 110 to generate the indices received from the bitstream 110. This may include the index of the selected mean vector, the index of the selected unitary transform matrix, and indices generated by the N number of VQ encoders of the encoder 102. Then, VQ decoding of an (i-th cluster and) n-th sub-vector is performed based on the codebook of an (i-th cluster and) n-th sub-vector based on the codebook 108 (e.g., a VQ decoding of an i-th cluster and a first sub-vector yᵢ^{k1}, a VQ decoding of an i-th cluster and an n-th sub-vector yᵢ^{kn}, and a VQ decoding of an i-th cluster and an N-th sub-vector yᵢ^{kN}).

Then, the vector merger merges the N sub-vectors to a quantized version of k-dimensional transformed SD, ŷᵢ^{k}. Then, an inverse (or transpose) of the unitary transform matrix, Ûᵢ^{k}, is multiplied by the quantized version of the k-dimensional transformed SD, via the inverse matrix multiplier. In the context of vectors, the multiplication may be viewed as a matrix multiplication of the k-dimensional transformed SD (vector) by the inverse of the unitary transform matrix (vector). The unitary transform matrix is selected by the decoder 104 from the unitary transform matrix codebook, such as the second entries of the codebook 106, based on the transmitted index of the selected unitary transform matrix from the bitstream 110. Then, the mean vector,

$${\hat{μ}}_{i}^{k} ,$$

is added to produce a (quantized) output k-dimensional SD, Ŝ^{k}ᵢ, by the adder. For example,

$${\hat{S}}_{i}^{k} = {\hat{U}}_{i}^{kT} {\hat{y}}_{i}^{k} + {\hat{μ}}_{i}^{k} .$$

The mean vector is also selected by the decoder 104 from the mean vector codebook, such as the first entries of a codebook 106, based on the transmitted index of the selected mean vector. As a result, higher bitrate reduction may be achieved.

In some implementations, a mere presence of the index of the selected mean vector and/or the index of the selected unitary transform matrix in the bitstream 110 may be interpreted by the decoder 104 as an instruction to add the mean vector and/or apply the inverse of the unitary transform matrix to compute the quantized k-dimensional SD. In some implementations, the received bitstream 110 may contain a flag, wherein the flag controls whether or not the mean vector and/or inverse of the unitary transform matrix is used (in the decoding side) for computing the SD.

The received bitstream 110 may also contain an SC corresponding to the SD. The SC may be produced from the HOA data, e.g., the mean subtracted HOA matrix. The SD may describe spatial aspects of the corresponding, or i-th, SC, such as its direction of arrival and its diffuseness. In some cases, the total number of SDs may be equal to the total number of corresponding SCs.

If the encoder 102 applies a unitary transform matrix, the inverse (or transpose) of the unitary transform matrix may be applied by the decoder 104. To achieve a complexity reduction of the decoder 104, the inverse (or transpose) operation may be simplified or removed. In one aspect, a codebook at the encoder 102 may store the unitary transform matrix while a codebook at the decoder 104 stores the inverse of the unitary transform matrix. In another aspect, a codebook at both the encoder 102 and the decoder 104 stores the inverse of the unitary transform matrix.

In some implementations, scalar quantization (SQ) encoding may be used in the system 100 as opposed to split vector quantization (SVQ). This may be referred to as a unitary transform based scalar quantization (UT-SQ). For example, encoding the k-dimensional transformed SD into the bitstream 110 by the encoder 102 may include SQ encoding the k-dimensional transformed SD. Furthermore, generating the k-dimensional transformed SD by the decoder 104 may include SQ decoding of the bitstream 110.

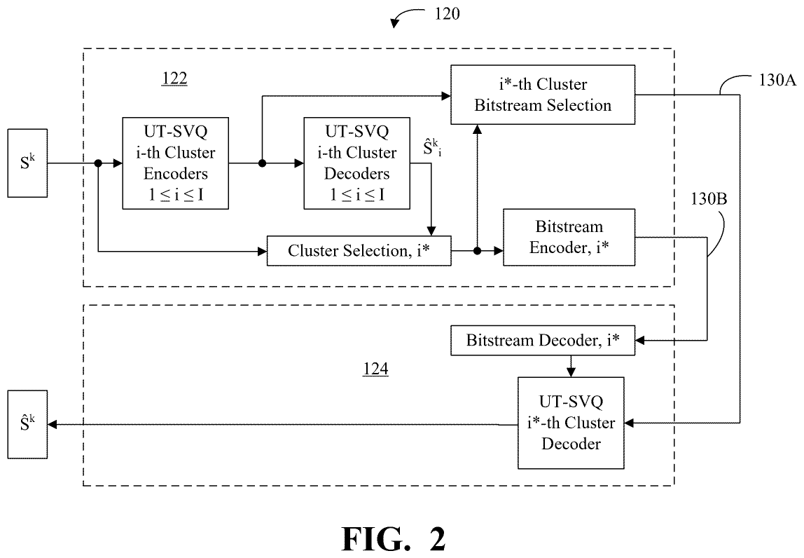

FIG. 2 is an example of a system 120 for processing SDs from HOA data. The SDs may be produced by performing PCA based upon an HOA matrix (e.g., a mean subtracted HOA matrix). The system 120 utilizes a unitary transform based multi-cluster split vector quantization (UT-MC-SVQ) technique as described below. The system 120 may also utilize one or more aspects of the system 100, e.g., the encoder 102, the decoder 104, the one or more codebooks, etc.

The system 120 may include an encoder 122 that encodes a bitstream and a decoder 124 that decodes the bitstream. The encoder 122 may include one or more UT-SVQ encoders (e.g., instances of the encoder 102), one or more UT-SVQ decoders (e.g., instances of the decoder 104), cluster selection, i*-th cluster bitstream selection, and a bitstream encoder. In an example of an encoding side of the process, an input k-dimensional SD, S^{k}, produced from HOA data, is encoded by the one or more UT-SVQ encoders and a best encoding, e.g., a bitstream 130A of an i*-th cluster SD, is selected by the i-th cluster bitstream selection for transmission to the decoder 124. In particular, the UT-SVQ encoder of an i-th cluster, where 1≤i≤I, generates the bitstreams of the i-th cluster. The bitstreams are decoded (at the encoder 122) via the UT-SVQ decoder of the i*-th cluster. At the encoder, a best cluster, i*, is selected by the cluster selection based on an error criterion, e.g., minimization of a quantization error. For example, i*=argmin_{1≤i≤I}∥Sₖ−Ŝ^{k}ᵢ∥². Then, the bitstream 130A of the i*-th cluster SD and a bitstream 130B of the best cluster index, i*, are transmitted to the decoder 124.

The decoder 124 may include a bitstream decoder, to decode the bitstream 130B, and a UT-SVQ decoder (e.g., the decoder 104) to decode the bitstream 130A. In an example of a decoding side of the process (UT-MC-SVQ decoding), the decoder 124, based on the decoded best cluster index, i*, may use the UT-SVQ decoder to perform UT-SVQ decoding of the i*-th cluster to obtain an output k-dimensional SD, Ŝ^{k}.

In some implementations, SQ encoding may be used in the system 120 as opposed to SVQ. This may be referred to as a unitary transform based multi-cluster scalar quantization (UT-MC-SQ). For example, encoding the bitstream 130A of the i-th cluster SD and the bitstream 130B of the best cluster index i may include SQ encoding. Furthermore, generating the output k-dimensional SD by the decoder 124 may include SQ decoding of the bitstream 130A and the bitstream 130B.

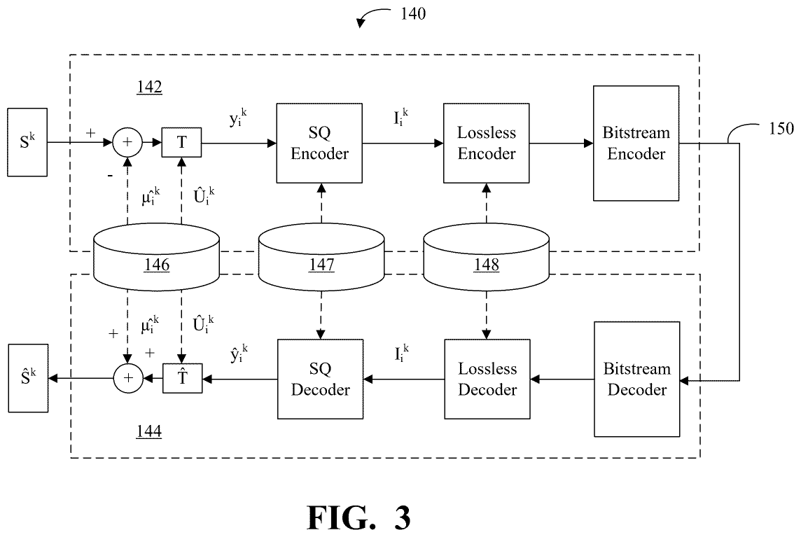

FIG. 3 is an example of a system 140 for processing SDs from HOA data. The SDs may be produced by performing matching pursuit based upon an HOA matrix (e.g., a mean subtracted HOA matrix). The system 140 utilizes a unitary transform based lossless coding (UT-LL) technique as described below. The system 120 may also utilize one or more aspects of the system 100 and/or the system 120.

The system 140 may include an encoder 142 that encodes the input SD to generate a bitstream 150, a decoder 144 that decodes the bitstream 150, and/or one or more codebooks. The encoder 102 may include a mean subtractor, a matrix multiplier, an SQ encoder, a lossless encoder, and a bitstream encoder. In an example of an encoding side of the process, from an input k-dimensional SD, S^{k}, produced from HOA data, a mean vector,

$${\hat{μ}}_{i}^{k} ,$$

is subtracted by the mean subtractor to produce a mean subtracted k-dimensional SD. The mean vector that is subtracted is selected from a mean vector codebook, such as a first entry of a codebook 146 (e.g., a mean vector and unitary transform codebook of an i-th cluster). An index of the selected mean vector may be transmitted to the decoder 144 in the bitstream 150.

From the mean subtracted k-dimensional SD, a unitary transform matrix, Ûᵢ^{k}, is multiplied via the matrix multiplier to produce a k-dimensional transformed SD, ŷᵢ^{k}. For example,

$${\hat{y}}_{i}^{k} = {\hat{U}}_{i}^{k} ( {S}^{k} - {\hat{μ}}_{i}^{k} ) .$$

In the context of vectors, the multiplication may be viewed as a matrix multiplication of the mean subtracted k-dimensional SD (vector) by the unitary transform matrix (vector). The unitary transform matrix that is multiplied is selected from a unitary transform matrix codebook, such as a second entry of the codebook 146. The index of the selected unitary transform matrix may also be transmitted to the decoder 144 in the bitstream 150. There may be multiple codebooks for a mean vector and a unitary transform matrix. In this example, the i-th codebook pair for a mean vector and a unitary transform matrix is shown.

The SQ encoder encodes an (i-th cluster and) n-th SQ element based on an SQ codebook 147 of an (i-th cluster and) n-th SQ element. For an (i-th cluster and) k-dimensional input yᵢ^{k}, the SQ encoder generates an (i-th cluster and) k-dimensional SQ indices, Iᵢ^{k}. Then, the lossless encoder encodes SQ indices based on a lossless encoding scheme, such as Huffman encoding, and a lossless coding codebook 148. The lossless encoding may encode an (i-th cluster and) n-th SQ element based on the lossless encoding codebook 148 of the (i-th cluster and) the n-th SQ element. Then, the bitstream encoder may generate the bitstream 150 (e.g., of an i-th cluster SD), including the index of the selected mean vector, the index of the selected unitary transform matrix, and the bitstream generated by the lossless encoder. The bitstream 150 may be transmitted to the decoder 144 and/or stored in a non-transitory machine-readable medium.

Still referring to FIG. 3, in an example of a decoding side of the process (UT-LL i-th cluster decoding), the decoder 144 may include a bitstream decoder, a lossless decoder, an SQ decoder, an inverse matrix multiplier, and an adder. The bitstream decoder may decode the received bitstream 150 to generate the indices received from the bitstream 150. This may include the index of the selected mean vector, the index of the selected unitary transform matrix, the bitstream generated by the lossless encoder. Then, the lossless decoder decodes the bitstream generated by the lossless encoder based on the lossless encoding scheme, such as Huffman encoding, and the lossless coding codebook 148. The lossless decoding may generate an (i-th cluster and) k-dimensional SQ indices, Iᵢ^{k}, based on the codebook 148 of the (i-th cluster and) the n-th SQ element.

Then, the SQ decoder decodes an (i-th cluster and) n-th SQ element based on the SQ codebook 147 of the (i-th cluster and) the n-th SQ element of Iᵢ^{k}, to produce the quantized version of a k-dimensional transformed SD, ŷᵢ^{k}. Then, an inverse (or transpose) of the unitary transform matrix, Ûᵢ^{k}, is multiplied by the quantized version of the k-dimensional transformed SD, via the inverse matrix multiplier. In the context of vectors, the multiplication may be viewed as a matrix multiplication of the k-dimensional transformed SD (vector) by the inverse of the unitary transform matrix (vector). The unitary transform matrix is selected by the decoder 144 from the unitary transform matrix codebook, such as the second entries of the codebook 146, based on the transmitted index of the selected unitary transform matrix from the bitstream 150. Then, the mean vector,

$${\hat{μ}}_{i}^{k} ,$$

is added to produce a (quantized) output k-dimensional SD, Ŝ^{k}ᵢ, by the adder. For example,

$${\hat{S}}_{i}^{k} = {\hat{U}}_{i}^{kT} {\hat{y}}_{i}^{k} + {\hat{μ}}_{i}^{k} .$$

The mean vector is also selected by the decoder 144 from the mean vector codebook, such as the first entries of a codebook 146, based on the transmitted index of the selected mean vector. As a result, higher bitrate reduction may be achieved.

In some implementations, a mere presence of the index of the selected mean vector and/or the index of the selected unitary transform matrix in the bitstream 150 may be interpreted by the decoder 144 as an instruction to add the mean vector and/or apply the inverse of the unitary transform matrix to compute the quantized k-dimensional SD. In some implementations, the received bitstream 150 may contain a flag, wherein the flag controls whether or not the mean vector and/or inverse of the unitary transform matrix is used (in the decoding side) for computing the SD.

The received bitstream 150 may also contain an SC corresponding to the SD. The SC may be produced from the HOA data, e.g., the mean subtracted HOA matrix. The SD may describe spatial aspects of the corresponding, or i-th, SC, such as its direction of arrival and its diffuseness. In some cases, the total number of SDs may be equal to the total number of corresponding SCs.

If the encoder 142 applies a unitary transform matrix, the inverse (or transpose) of the unitary transform matrix may be applied by the decoder 144. To achieve a complexity reduction of the decoder 144, the inverse (or transpose) operation may be simplified or removed. In one aspect, a codebook at the encoder 142 may store the unitary transform matrix while a codebook at the decoder 144 stores the inverse of the unitary transform matrix. In another aspect, a codebook at both the encoder 142 and the decoder 144 stores the inverse of the unitary transform matrix.

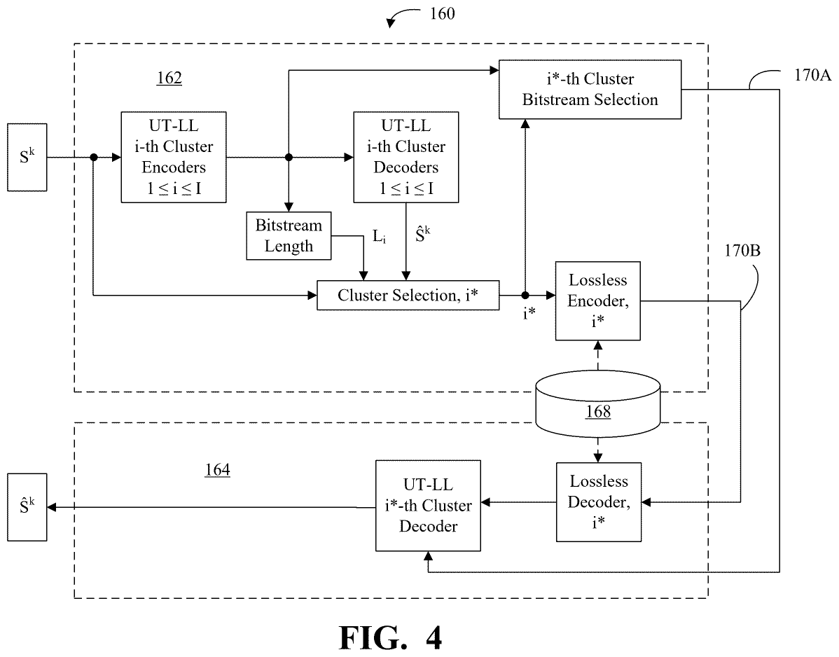

FIG. 4 is an example of a system 160 for processing SDs from HOA data. The SDs may be produced by performing matching pursuit based upon an HOA matrix (e.g., a mean subtracted HOA matrix). The system 160 utilizes a unitary transform based multi-cluster lossless coding (UT-MC-LL) technique as described below. The system 160 may also utilize one or more aspects of the system 100, the system 120, and/or the system 140.

The system 160 may include an encoder 162 that encodes a bitstream and a decoder 164 that decodes the bitstream. The encoder 162 may include one or more UT-LL encoders (e.g., instances of the encoder 142), one or more UT-LL decoders (e.g., instances of the decoder 144), cluster selection, i*-th cluster bitstream selection, and a lossless encoder. In an example of an encoding side of the process, an input k-dimensional SD, S^{k}, produced from HOA data, is encoded by the one or more UT-LL encoders and a best encoding, e.g., a bitstream 170A of an i*-th cluster SD, is selected by the i*-th cluster bitstream selection for transmission to the decoder 164. In particular, the UT-LL encoder of an i-th cluster, where 1≤i≤I, generates the bitstreams of the i-th cluster. The bitstreams are decoded (at the encoder 142) via the UT-LL decoder of the i*-th cluster. At the encoder, a best cluster, i*, is selected by the cluster selection based on an error criterion, e.g., minimization of a quantization error and/or codeword length, Lᵢ, of the lossless coding (e.g., the Huffman coding). For example, i*=argmin_{1≤i≤I}∥S^{k}−Ŝ^{k}ᵢ∥²+αLᵢ. Then, the bitstream 170A of the i*-th cluster SD, and a bitstream 170B of the best cluster index, i*, encoded by the lossless encoder based on lossless encoding codebook 168, are transmitted to the decoder 164.

The decoder 164 may include a lossless decoder, to decode the bitstream 170B based on the codebook 168, and a UT-LL decoder (e.g., the decoder 144) to decode the bitstream 170A. In an example of a decoding side of the process (UT-MC-LL decoding), the decoder 164, based on the decoded best cluster index, i*, may use the UT-LL decoder to perform lossless decoding of the i*-th cluster to obtain an output k-dimensional SD, Ŝ^{k}.

As described herein, higher bitrate reduction may be achieved by processing the SDs by one or more of mean vector subtraction, unitary transformation, clustering, and/or lossless encoding, among other techniques. For example, with in input HOA order of 4 (number of HOA coefficients of 25), and a number of SD parameters per frame of 16, conventional encoders utilizing SQ (dimensions for sub-vectors of 1, 1, 1, 1, 1, 1, 1, 1, 1, 1, 1, 1, 1, 1, 1, 1, 1, 1, 1, 1, 1, 1, 1, 1, 1, totaling 25) might have a bit rate of at least 100 kbps with a given signal to noise ratio (SNR). Similarly, conventional encoders utilizing SVQ (dimensions for sub-vectors of 3, 3, 3, 3, 3, 3, 3, 4, totaling 25) might have a comparable bit rate with a comparable SNR. In contrast, encoders utilizing the techniques described herein may achieve even lower bit rates, e.g., less than 100 kbps, with a comparable SNR. For example, an encoder utilizing UT-MC-SVQ (e.g., the encoder 122, applying unitary transformation, clustering, and split vector quantization) with 4 clusters (dimensions for sub-vectors of 3, 2, 2, 2, 2, 2, 2, 2, 2, 2, 2, 2, totaling 25) may achieve the lower bit rate with a comparable SNR. In another example, an encoder utilizing UT-MC-SQ (e.g., a variation of the encoder 122, applying unitary transformation, clustering, and scalar quantization) with 4 clusters (dimensions for sub-vectors of 1, 1, 1, 1, 1, 1, 1, 1, 1, 1, 1, 1, 1, 1, 1, 1, 1, 1, 1, 1, 1, 1, 1, 1, 1, totaling 25) may also achieve the lower bit rate with a comparable SNR. In a further example, an encoder utilizing UT-MC-LL (e.g., the encoder 162, applying mean vector subtraction, unitary transformation, clustering, and Huffman coding) with 4 clusters (dimensions for sub-vectors of 1, 1, 1, 1, 1, 1, 1, 1, 1, 1, 1, 1, 1, 1, 1, 1, 1, 1, 1, 1, 1, 1, 1, 1, 1, totaling 25) may achieve an even lower bit rate with a comparable SNR. Thus, as described herein, higher bitrate reduction may be achieved.

Reference is now made to flowcharts of examples of processes for producing a k-dimensional SD from HOA data. The processes can be executed using computing devices, such as the systems, hardware, and software described with respect to FIGS. 1-4. The processes can be performed, for example, by executing a machine-readable program or other computer-executable instructions, such as routines, instructions, programs, or other code. The operations of the processes or other techniques, methods, or algorithms described in connection with the implementations disclosed herein can be implemented directly in hardware, firmware, software executed by hardware, circuitry, or a combination thereof.

For simplicity of explanation, the processes are depicted and described herein as a series of operations. However, the operations in accordance with this disclosure can occur in various orders and/or concurrently. Additionally, other operations not presented and described herein may be used. Furthermore, not all illustrated operations may be required to implement a process in accordance with the disclosed subject matter.

PCA may utilize a multiple sub-band HOA encoder and/or decoder. For example, an input may include an NxM matrix where N and M refer to a frame size (e.g., 2048 samples) and a number of input HOA coefficients, respectively. The input may be filtered or transformed and each sub-band input signal may be processed by PCA to produce sub-band wise SDs and SCs. An SD and SC for each sub-band may be encoded to generate a bitstream which may be transmitted to the decoder. The decoder may reconstruct the SD and SC for each sub-band, which may be used to synthesize the sub-band wise HOA signals. The synthesized HOA signals may be filtered or transformed to produce the time-domain HOA signals. See, for example, U.S. Patent Application Publication No. 2023/0360655A1, entitled “Higher Order Ambisonics Encoding and Decoding,” assigned to Apple Inc., which is incorporated by reference herein.

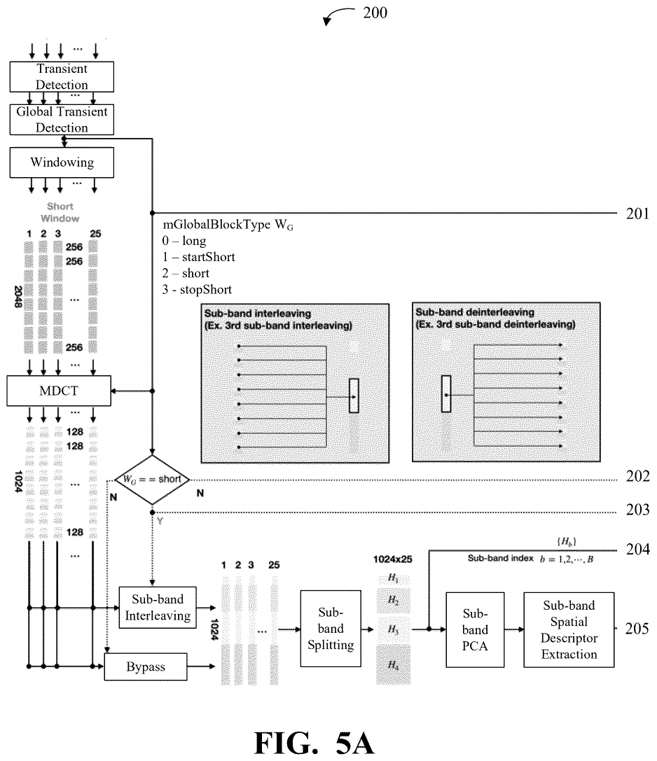

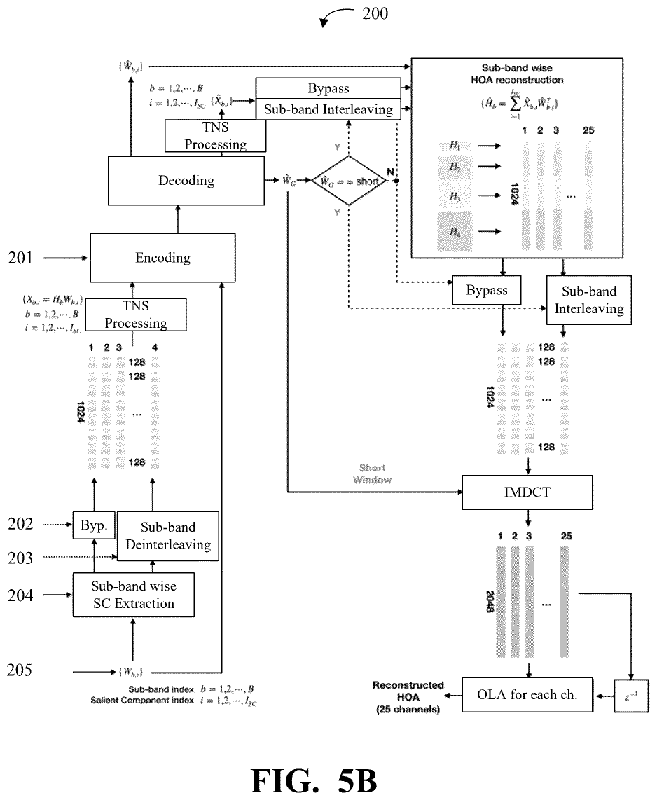

FIGS. 5A-5B show an example of a process 200 (connected via points 201 to 205) that includes processing HOA data with PCA coding and window switching in which a global window shape is SHORT_WINDOW. The process 200 may be utilized to produce an SD and SC from HOA data and reconstruct the HOA data from the SD and SC. In particular, PCA coding with window switching is shown in the process 200. In this case, the global window shape is SHORT_WINDOW. As an example, the number of input HOA coefficients is 25 (e.g., a 4th order HOA), but it should not be limited by this number. Transient detection for each coefficient may be made and one of the following window shapes may be selected: LONG_WINDOW, LONG_START_WINDOW, SHORT_WINDOW, or LONG_STOP_WINDOW, but does not have to be limited by this set. Based on the 25 window types, a global transient detection is made, which generates a single global window shape. The global window shape is also one of the following types: LONG_WINDOW, LONG_START_WINDOW, SHORT_WINDOW, or LONG_STOP_WINDOW, but does not have to be limited by this set. The global window shape is encoded (e.g., 2 bits to represent LONG_WINDOW, LONG_START_WINDOW, SHORT_WINDOW, or LONG_STOP_WINDOW in this example). The global window shape is used for every HOA coefficient. In this example, the global window shape is SHORT_WINDOW, thus each HOA coefficient is analyzed by using 8 short windows and MDCT analysis for each window is followed. If the global window shape is SHORT_WINDOW, MDCT coefficients for each HOA channel are processed by sub-band interleaving to aggregate similar frequency components into a sub-band. Thus, sub-band interleaving can collect similar frequency components (from different time-domain locations) into a sub-band. For each sub-band, conventional sub-band PCA (HOA encoding and decoding) is applied for each sub-band components to produce the sub-band wise SDs and SCs. If the global window shape is SHORT_WINDOW, sub-band-wise SC is processed by sub-band de-interleaving to place the MDCT coefficients back to the original positions. If the global window shape is SHORT_WINDOW, encoding of SC is performed for each short window. For any window shapes, SD is encoded, e.g., based on HOA encoding and decoding. A bitstream for SC, SD, and the global window shape (e.g., 2 bits to represent LONG_WINDOW, LONG_START_WINDOW, SHORT_WINDOW, or LONG_STOP_WINDOW in this example) is transmitted to the decoder. At the decoder, based on the received bitstreams, SC, SD, and the global window shape are decoded and reconstructed. If the global window shape is SHORT_WINDOW, decoding of SC is performed for each short window. If the decoded global window shape is SHORT_WINDOW, MDCT coefficients for each SC are processed by sub-band interleaving to aggregate similar frequency components into the same sub-band. For each sub-band, HOA reconstruction may be made based on decoded SD and SC. If the global window shape is SHORT_WINDOW, sub-band wise SC is processed by sub-band de-interleaving to place the MDCT coefficients back to the original positions. IMDCT and overlap-add (OLA) synthesis are followed to reconstruct the time-domain HOA signals. If the global window shape is SHORT_WINDOW, short-window-based IMDCT and OLA synthesis are performed.

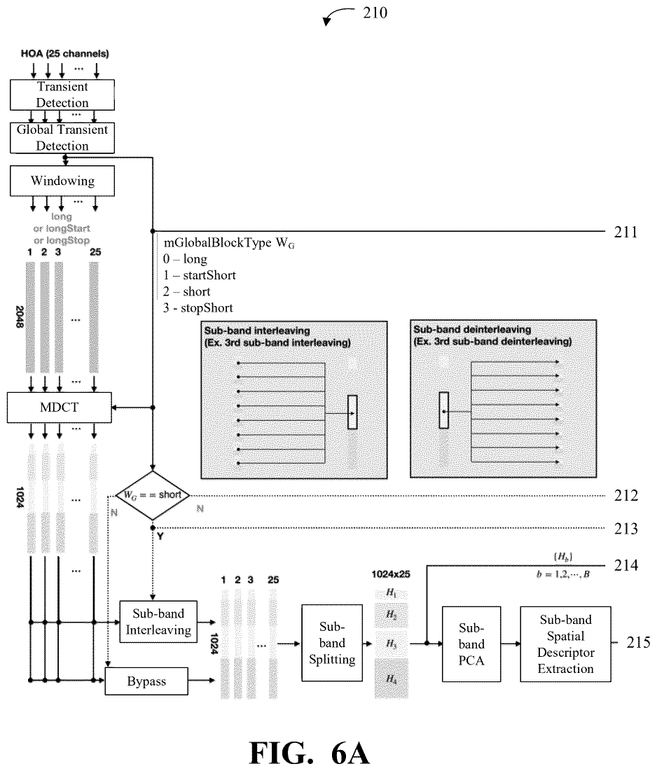

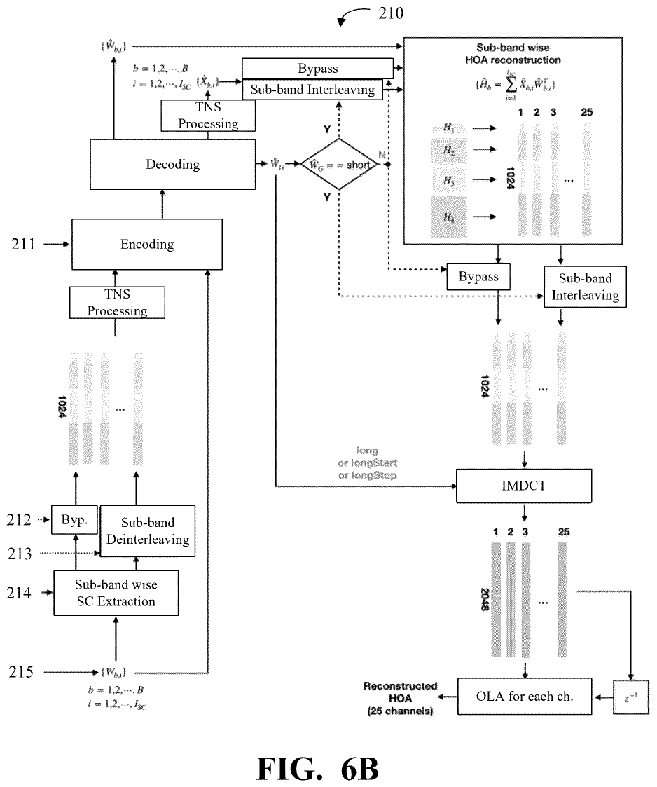

FIGS. 6A-6B show an example of a process 210 (connected via points 211 to 215) that includes processing HOA data with PCA coding and window switching in which a global window shape is not SHORT_WINDOW. The process 210 may be utilized to produce an SD and SC from HOA data and reconstruct the HOA data from the SD and SC. In particular, window switching if the global window shape is other than a SHORT_WINDOW is shown in the process 210. If the global window shape is LONG_WINDOW, LONG_START_WINDOW, or LONG_STOP_WINDOW, all sub-band interleaving and de-interleaving modules are bypassed. IMDCT and OLA synthesis are followed to reconstruct the time-domain HOA signals. If the global window shape is other than SHORT_WINDOW, associated IMDCT and OLA synthesis are performed.

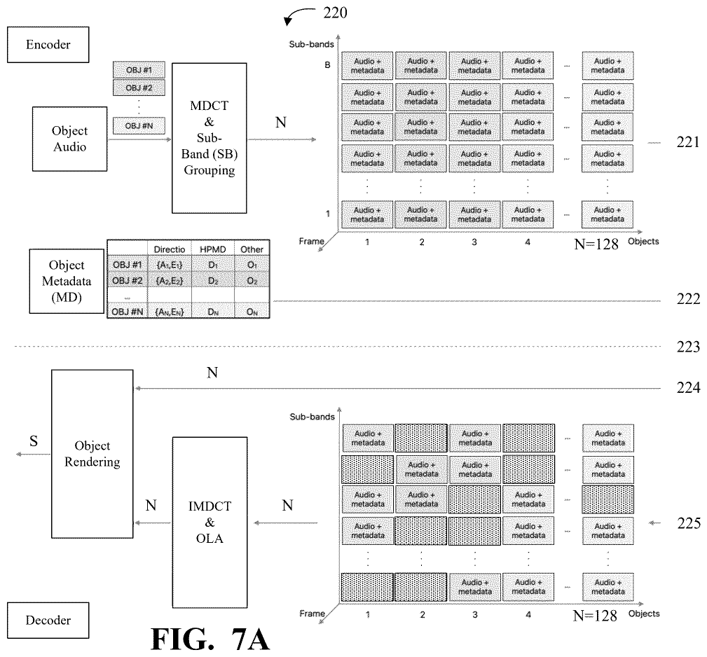

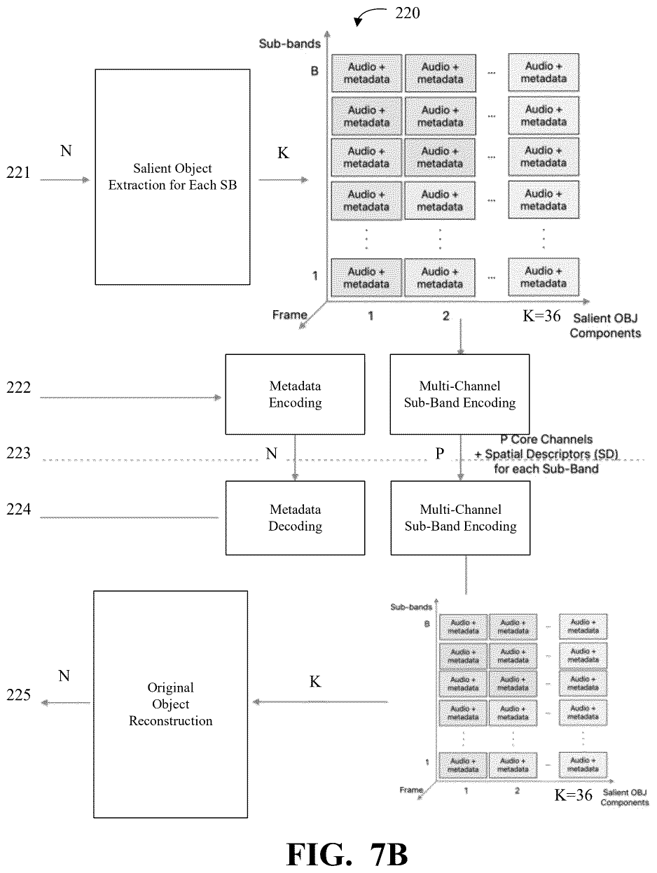

FIGS. 7A-7B show an example of a process 220 (connected via points 221 to 225) that includes a dynamic selection of salient objects for each sub-band. The process 220 may be utilized to produce an SD and SC from HOA data and reconstruct the HOA data from the SD and SC. In the process 220, N Object Audio Signals (e.g., N=128) may be transformed to a frequency domain (e.g., with modified discrete cosine transform (MDCT) or quadrature mirror filter (QMF)) and sub-band grouping provides the representation for each Time-Frequency (TF) tile. For each sub-band, K salient object TF components (e.g., K=36) are selected based on the priorities, e.g., energy. Multi-channel sub-band coding, e.g., PCA coding (based on HOA coding and decoding), is applied to the TF components for each sub-band, which reduces the number of transport channels to P (e.g., P=4). P transport channels are coded with core audio coding, e.g. AAC. P Spatial Descriptors (SD) of each sub-band are quantized and transmitted. At the decoder, based on the transmitted bitstream, a quantized version of the step 2 (K salient object TF components for each sub-band) are reconstructed. From the output of the decoder, quantized version of the original N objects are reconstructed, which only has K non-empty object TF components. They are transformed back to the time-domain Object Audio Signals. N Object Metadata (MD) are encoded/transmitted/decoded. A quantized version of N Object Audio Signals and N Object Metadata (MD) are rendered to S Output Audio Signals by an Object Renderer.

It should be appreciated that various aspects of the techniques described herein may be combined to achieve higher bitrate reduction. For example, aspects of the systems 100, 120, 140, and/or 160 may be combined. Additionally, the systems 100, 120, 140, and/or 160 may perform one or more of the processes 200, 210, and/or 220 to process HOA data. As a result, the systems 100, 120, 140, and/or 160 may achieve higher bitrate reduction.

Some implementations may include a method for encoding a k-dimensional SD produced from HOA data. The method may include multiplying a unitary transform matrix by an input k-dimensional SD to produce a k-dimensional transformed SD; and encoding the k-dimensional transformed SD into a bitstream to be transmitted to a decoder. In some implementations, the method includes subtracting a mean vector from the input k-dimensional SD. In some implementations, the mean vector is selected from one of a plurality of mean vector codebooks, and an index of the mean vector is transmitted with the bitstream. In some implementations, the unitary transform matrix is selected from one of a plurality of transform codebooks, and an index of the unitary transform matrix is transmitted with the bitstream. In some implementations, encoding into the bitstream includes splitting the k-dimensional transformed SD into N sub-vectors. In some implementations, the N sub-vectors include sub-vectors with different dimensions. In some implementations, encoding into the bitstream includes generating N indices corresponding to N sub-vectors. In some implementations, encoding into the bitstream includes VQ encoding the k-dimensional transformed SD. In some implementations, encoding into the bitstream includes SQ encoding the k-dimensional transformed SD. In some implementations, the k-dimensional transformed SD of an i-th cluster is obtained by using both an i-th mean vector and an i-th unitary transform matrix from one or more codebooks containing a plurality of mean vectors and unitary transform matrices where 1≤i≤I. In some implementations, the k-dimensional transformed SD of an i-th cluster is obtained by using an i-th unitary transform matrix from one or more codebooks containing a plurality of unitary transform matrices where 1≤i≤I. In some implementations, the method includes selecting an i-th cluster of a split VQ encoding of the k-dimensional transformed SD. In some implementations, the i-th cluster is selected based on minimization of a quantization error. In some implementations, the method includes selecting an i-th cluster of an SQ encoding of the k-dimensional transformed SD. In some implementations, encoding into the bitstream includes Huffman or any lossless encoding of SQ elements produced by an SQ encoding of the k-dimensional transformed SD. In some implementations, SQ indices of the SQ elements are encoded based on a codebook. In some implementations, the method includes selecting an i-th cluster of a Huffman or any lossless encoding of SQ elements produced by an SQ encoding of the k-dimensional transformed SD. In some implementations, the i-th cluster is selected based on minimization of at least one of a quantization error or a codeword length of Huffman encoding. In some implementations, the input k-dimensional SD is produced by performing PCA or any transform based upon an HOA matrix. In some implementations, the method includes encoding into the bitstream a k-dimensional SC produced from HOA data.

Some implementations may include method for decoding a k-dimensional SD produced from HOA data. The method may include receiving a bitstream; generating a k-dimensional transformed SD based on the bitstream; determining an inverse of a unitary transform; and multiplying the k-dimensional transformed SD by the inverse of the unitary transform to produce an output k-dimensional SD to reconstruct HOA data. In some implementations, the method includes adding a mean vector to the k-dimensional transformed SD. In some implementations, the mean vector is selected from one of a plurality of mean vector codebooks, and an index of the mean vector is received with the bitstream. In some implementations, the inverse of the unitary transform is selected from one of a plurality of transform codebooks, and an index of the inverse of the unitary transform is received with the bitstream. In some implementations, generating the k-dimensional transformed SD includes merging N sub-vectors of the bitstream. In some implementations, the N sub-vectors include sub-vectors with different dimensions. In some implementations, merging N sub-vectors includes utilizing N indices received in the bitstream corresponding to N sub-vectors. In some implementations, generating the k-dimensional transformed SD includes VQ decoding. In some implementations, generating the k-dimensional transformed SD includes SQ decoding. In some implementations, generating the k-dimensional transformed SD includes decoding of an i-th cluster of a split VQ encoding. In some implementations, generating the k-dimensional transformed SD includes decoding an i-th cluster of an SQ encoding. In some implementations, generating the k-dimensional transformed SD includes Huffman or any lossless decoding of the bitstream to produce SQ elements. In some implementations, SQ indices of the SQ elements are received in the bitstream. In some implementations, generating the k-dimensional transformed SD includes Huffman or any lossless decoding of an i-th cluster. In some implementations, the output k-dimensional SD is used to reconstruct HOA data. In some implementations, the method includes decoding from the bitstream a k-dimensional SC produced from HOA data.

Some implementations may include method for processing a bitstream including a k-dimensional SD produced from HOA data. The method may include receiving a bitstream that includes a k-dimensional transformed SD and a transform index; and processing the bitstream by multiplying the k-dimensional transformed SD by an inverse of a unitary transform matrix determined from a transform codebook based on the transform index to produce an output k-dimensional SD to reconstruct HOA data. In some implementations, the method includes processing the bitstream to add a mean vector to the k-dimensional transformed SD. In some implementations, the mean vector is selected from one of a plurality of mean vector codebooks, and an index of the mean vector is received with the bitstream. In some implementations, the inverse of the unitary transform is selected from one of a plurality of transform codebooks, and an index of the inverse of the unitary transform is received with the bitstream. In some implementations, processing the bitstream includes merging N sub-vectors of the bitstream. In some implementations, the N sub-vectors include sub-vectors with different dimensions. In some implementations, merging N sub-vectors includes utilizing N indices received in the bitstream corresponding to N sub-vectors. In some implementations, processing the bitstream includes performing VQ decoding. In some implementations, processing the bitstream includes performing SQ decoding. In some implementations, processing the bitstream includes decoding an i-th cluster of a split VQ encoding. In some implementations, processing the bitstream includes decoding an i-th cluster of an SQ encoding. In some implementations, processing the bitstream includes Huffman or any lossless decoding of the bitstream to produce SQ elements. In some implementations, SQ indices of the SQ elements are received in the bitstream. In some implementations, processing the bitstream includes Huffman or any lossless decoding of an i-th cluster. In some implementations, processing the bitstream includes using the output k-dimensional SD to reconstruct HOA data. In some implementations, the method includes processing the bitstream to decode an SC produced from HOA data.

An aspect of the disclosure may include a non-transitory machine-readable medium (such as computer memory) having stored thereon instructions, which program one or more data processing components (generically referred to here as a “processor”) to (automatically) perform operations, as described herein. In other aspects, some of these operations might be performed by specific hardware components that contain hardwired logic. Those operations might alternatively be performed by any combination of programmed data processing components and fixed hardwired circuit components. A “processor” may include a distributed arrangement where multiple processors are configured and controlled to perform the recited operations or tasks together, e.g., one processor can perform some of the recited operations and another processor can perform others of the recited operations.

As used herein, the term “circuitry” refers to an arrangement of electronic components (e.g., transistors, resistors, capacitors, and/or inductors) that is structured to implement one or more functions. For example, a circuit may include one or more transistors interconnected to form logic gates that collectively implement a logical function.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures.

What is claimed is:

1. A method for decoding a k-dimensional spatial descriptor (SD) produced from higher order ambisonics (HOA) data, comprising:
receiving a bitstream;
generating a k-dimensional transformed SD based on the bitstream;
determining an inverse of a unitary transform; and
multiplying the k-dimensional transformed SD by the inverse of the unitary transform to produce an output k-dimensional SD to reconstruct HOA data.

2. The method of claim 1, further comprising:
adding a mean vector to the k-dimensional transformed SD.

3. The method of claim 2, wherein the mean vector is selected from one of a plurality of mean vector codebooks, and wherein an index of the mean vector is received with the bitstream.

4. The method of claim 1, wherein the inverse of the unitary transform is selected from one of a plurality of transform codebooks, and wherein an index of the inverse of the unitary transform is received with the bitstream.

5. The method of claim 1, wherein generating the k-dimensional transformed SD includes merging N sub-vectors of the bitstream.

6. The method of claim 5, wherein the N sub-vectors include sub-vectors with different dimensions.

7. The method of claim 5, wherein merging N sub-vectors includes utilizing N indices received in the bitstream corresponding to N sub-vectors.

8. The method of claim 5, wherein generating the k-dimensional transformed SD includes split vector quantization (VQ) decoding.

9. The method of claim 1, wherein generating the k-dimensional transformed SD includes scalar quantization (SQ) decoding.

10. The method of claim 1, wherein generating the k-dimensional transformed SD includes decoding of an i-th cluster of a split VQ encoding.

11. The method of claim 1, wherein generating the k-dimensional transformed SD includes decoding an i-th cluster of an SQ encoding.

12. The method of claim 1, wherein generating the k-dimensional transformed SD includes Huffman or any lossless decoding of the bitstream to produce k-dimensional SQ elements followed by SQ decoding of the k-dimensional SQ elements.

13. The method of claim 1, generating the k-dimensional transformed SD includes Huffman or any lossless decoding of an i-th cluster.

14. The method of claim 1, wherein the output k-dimensional SD is used to reconstruct HOA data.

15. The method of claim 1, further comprising:
decoding from the bitstream a k-dimensional salient component (SC) produced from HOA data.

16. A method for processing a bitstream including a k-dimensional spatial descriptor (SD) produced from higher order ambisonics (HOA) data, comprising:
receiving a bitstream that includes a k-dimensional transformed SD and a transform index; and
processing the bitstream by multiplying the k-dimensional transformed SD by an inverse of a unitary transform matrix determined from a transform codebook based on the transform index to produce an output k-dimensional SD to reconstruct HOA data.

17. The method of claim 16, further comprising:
processing the bitstream to add a mean vector to the k-dimensional transformed SD.

18. The method of claim 17, wherein the mean vector is selected from one of a plurality of mean vector codebooks, and wherein an index of the mean vector is received with the bitstream.

19. The method of claim 16, wherein the inverse of the unitary transform matrix is selected from one of a plurality of transform codebooks, and wherein an index of the inverse of the unitary transform matrix is received with the bitstream.

20. A method for encoding a k-dimensional spatial descriptor (SD) produced from higher order ambisonics (HOA) data, comprising:
multiplying a unitary transform matrix by an input k-dimensional SD to produce a k-dimensional transformed SD; and
encoding the k-dimensional transformed SD into a bitstream to be transmitted to a decoder.
